(19) United States
(12) Patent Application Publication
(10) Pub. No.: US 2003/0086427 A1
(43) Pub. Date: May 8, 2003

(54) Method and apparatus for retransmitting packet data between base station controller and base transceiver system in a mobile communication system

(75) Inventors: Sung-Won Lee, Songnam-shi (KR); Young-Ky Kim, Seoul (KR); Dong-Soo Park, Seoul (KR); Dong-Jun Lee, Songnam-shi (KR); Sang-Soo Kim, Songnam-shi (KR); Jin-Sung Cho, Yongin-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/290,949

(22) Filed: Nov. 8, 2002

(30) Foreign Application Priority Data
Nov. 8, 2001 (KR) P2001-69425

(51) Int. Cl. H04L 12/28

(52) U.S. Cl. 370/394; 370/349

(57) ABSTRACT

A method and apparatus for retransmitting packet data lost during its transmission from a BSC to a BTS in a mobile communication system. The BTS sequentially receives packets from the BSC and determines whether there is a lost packet. When packet loss is detected, the BTS buffers packets received after a lost packet and requests a retransmission of the lost packet to the BSC. The BSC retransmits the lost packet to the BTS in response to the retransmission request. The BTS rearranges the retransmitted packet and the buffered packets according to the right order and transmits the rearranged packets to an MS.

### PRIORITY

This application claims priority to an application entitled “Method and Apparatus for Retransmitting Packet Data between Base Station Controller and Base Transceiver System in a Mobile Communication System” filed in the Korean Industrial Property Office on Nov. 8, 2001 and assigned Serial No. 2001-69425, the contents of which are hereby incorporated by reference.

### BACKGROUND OF THE INVENTION

1. Field of the Invention

The present invention relates generally to transmission of packet data in a mobile communication system, and in particular, to an apparatus and method for retransmitting packet data which are lost during transmission between a base station controller (BSC) and a base transceiver system (BTS).

2. Description of the Related Art

In general, a mobile communication system, such as CDMA2000 (Code Division Multiple Access 2000), WCDMA/UMTS (Wideband Code Division Multiple Access)/(Universal Telecommunication System), GPRS (General Packet Radio System), and CDMA2000 1×EV-DO (Evolution-Data Only), includes a BSC, BTS, and a mobile station (MS). The BSC is connected to the BTS by cable and the BTS is connected to the MS wirelessly for communication. A typical mobile communication system provides only voice service to subscribers. Along with the development of mobile communication technology, the mobile communication system additionally provides packet data service.

An RLP (Radio Link Protocol) is usually used for error correction on a radio link in the mobile communication system. When a BSC communicates with a particular MS through a corresponding BTS, data communication is carried out by the RLP to correct errors on the radio link. According to the RLP, the BSC transmits packet data (or RLP packets) sequentially to the BTS, specifically, to channel cards in the BTS. The BTS then stores the received RLP packets in its buffer and sequentially transmits the buffered packet data to the MS when radio resources are available. If some received packet data is lost during the transmission, the MS requests a retransmission of the lost packet data to the BTS. Thus, errors on the radio link are corrected. It is to be noted here that the BTS takes no measures even if packet data received from the BSC includes lost data.

The packet data transmitted from the BSC may be lost on a wired link or on the radio link between the BSC and the MS. However, without considering the link where packet loss has occurred, an RLP processor in the MS detects the packet loss and carries out a retransmission procedure with an RLP processor in the BSC. This retransmission procedure is limited as compared to wired transmission, and leads to expensive radio resources consumption. Moreover, transmission of unnecessary signaling results in delay of packet data transmission.

### SUMMARY OF THE INVENTION

It is, therefore, an object of the present invention to provide a method and apparatus for detecting packet data lost on a wired link during transmission from a BSC to an MS through a BTS and recovering the packet data in a mobile communication system.

It is another object of the present invention to provide a method and apparatus for recovering packet data lost on a wired link during transmission from a BSC to an MS through a BTS without consuming radio resources in a mobile communication system.

It is a further object of the present invention to provide a method and apparatus for minimizing transmission delay caused by packet data loss during transmission from a BSC to an MS through a BTS in a mobile communication system.

It is still another object of the present invention to provide a method and apparatus for preventing the decrease of radio resources efficiency caused by packet data loss and this increasing transmission reliability in a mobile communication system.

To achieve the above and other objects, a BTS sequentially receives packets from a BSC and determines whether there is a lost packet. When packet loss is detected, the BTS buffers packets received after a lost packet and requests from the BSC a retransmission of the lost packet. The BSC retransmits the lost packet to the BTS in response to the retransmission request. The BTS rearranges the retransmitted packet and the buffered packets according to the right order and transmits the rearranged packets to an MS.

It is preferred that the BTS determines whether the requested packet has been received within a predetermined time period after transmitting the retransmission request. If the requested packet is not received from the BSC within the predetermined time period, the BTS transmits the buffered packets to the MS. The BTS determines whether packet loss has occurred by checking the sequence numbers of the packets received from the BSC. The BTS requests the retransmission to the BSC by IPC (Inter-Processor Communication).

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile communication system to which the present invention is applied;

FIG. 2 is a block diagram of a BSC illustrated in FIG. 1;

FIG. 3 is a block diagram of a BTS illustrated in FIG. 1;

FIG. 4 is a block diagram of a channel card illustrated in FIG. 3;

FIG. 5 is a diagram illustrating a signal flow for packet data retransmission according to an embodiment of the present invention;

FIG. 6 is a block diagram of the BSC and the BTS for packet data retransmission according to the embodiment of the present invention;

FIG. 7 is a flowchart illustrating the operation of the BTS for packet data retransmission according to the embodiment of the present invention; and

FIG. 8 is a flowchart illustrating the operation of the BSC for packet data retransmission according to the embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

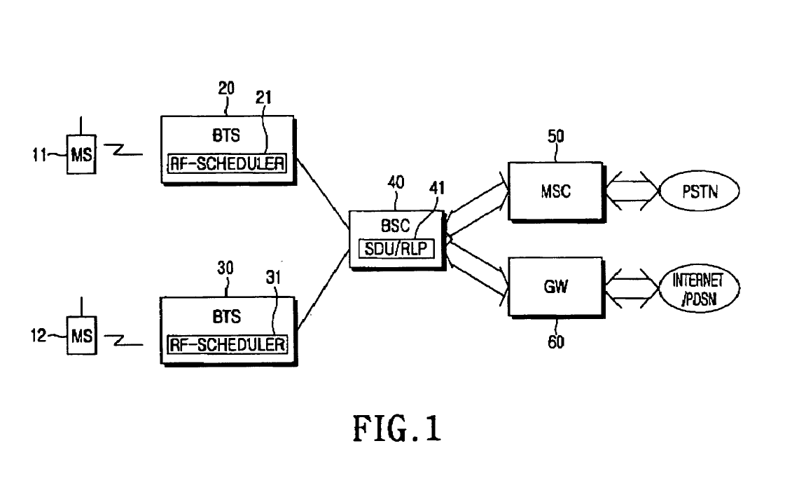

FIG. 1 illustrates the network configuration of a mobile communication system to which the present invention is applied. The mobile communication system supports packet service as well as voice service to mobile subscribers. The structure illustrated in FIG. 1 is a generalized one, and the components are termed depending on which system is used (e.g., IS-2000, WCDMA, UMTS, CDMA2000, 1×EV-DO, GPRS, and 1EV-DV).

Referring to FIG. 1, the mobile communication system includes MSs 11 and 12, BTSs 20 and 30 connected wirelessly to the MSs 11 and 12 for communication, and a BSC 40 connected to the BTSs 20 and 30 for communication. The BSC 40 is connected to an MSC (Mobile Switching Center) 50 and a gateway (GW) 60. The MSC 50 is connected to a PSTN (Public Switched Telephone Network) and the GW 60 is connected to the Internet/PDSN (Packet Data Serving Node). When the MS 11 is connected to the PSTN via the MSC 50 under the control of the BSC 40, a voice service is provided to the MS 11. If the MS 11 is connected to the Internet/PDSN via the GW 60, a packet service is provided to the MS 11.

The BTSs 20 and 30 have RF (Radio Frequency) schedulers 21 and 31, respectively, and the BSC 40 includes an SDU (Selection & Distribution Unit)/RLP processor 41. The RF schedulers 21 and 31 enable the BTSs 20 and 30 to use radio resources efficiently and assign the radio resources appropriately to a plurality of users. The SDU processor 41 functions to transmit traffic to a plurality of BTSs and combine the same data received from an MS through a BTS. While the SDU processor 41 may be location in the GW 60, it is assumed that the SDU processor 41 is provided within the BSC 40. The RLP processor 41 converts packets received from the GW 60 in an error control protocol frame structure for transmission to the BTSs 20 and 30. Notably, the BTSs 20 and 30 have limited buffer space for users. Therefore, if the BTSs 20 and 30 receive more traffic than can be accommodated from the BSC 40, they experience traffic loss. To prevent the traffic loss, flow control is performed.

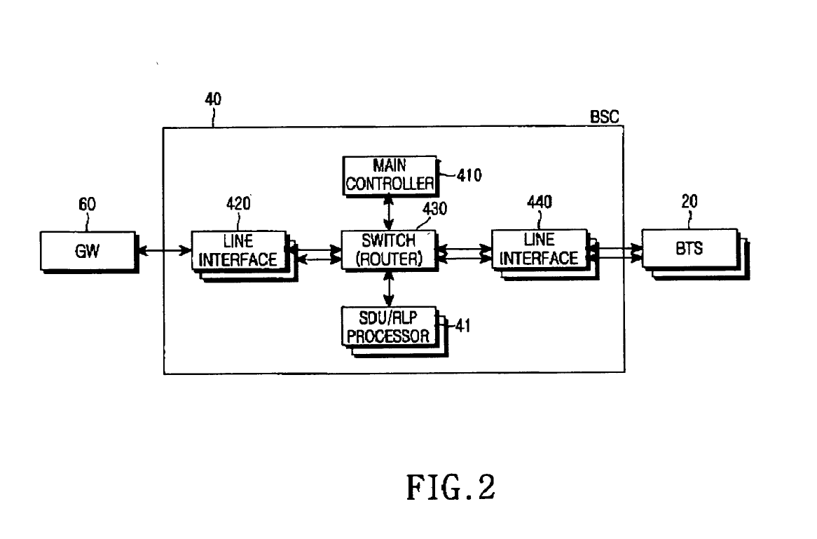

FIG. 2 is a detailed block diagram of the BSC 40 illustrated in FIG. 1. Referring to FIG. 2, the BSC 40 is comprised of a main controller 410, a line interface (or network interface) 420, a switch (or router) 430, and a line interface 440. The main controller 410 provides overall control to the BSC 40. The line interface 420 connects the BSC 40 to the GW 60, and the line interface 440 connected the BSC 40 to the BTS 20. The switch 430 routes traffic within the BSC 40. The SDU processor 41 multiplexes traffic to be transmitted on at least two links and demultiplexes traffic received on the links at a soft handover. The RLP processor 41 supports radio link error correction.

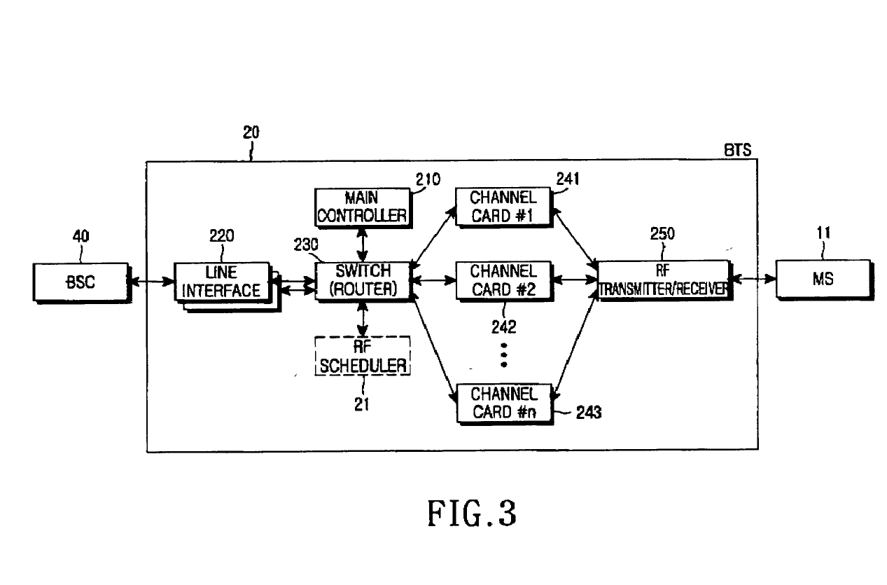

FIG. 3 is a detailed block diagram of the BTS 20 illustrated in FIG. 1. The following description is also applied to the BTS 30.

Referring to FIG. 3, the BTS 20 includes a main controller 210, a line interface 220, a switch (or router) 230, channel cards 241 to 243, an RF transmitter/receiver 250, and an RF scheduler 21. The main controller 210 provides overall control to the BTS 20. The line interface 220 connects the BTS 20 to the BSC 40. The RF transmitter/receiver 250 exchanges data and control signals with the MS 11. The switch 230 determines a traffic path within the BTS 20. The RF scheduler 21 supports efficient management of radio resources. The RF scheduler 21 may be implemented as an independent processor as shown, or in soft ware within the channel cards 241 to 243.

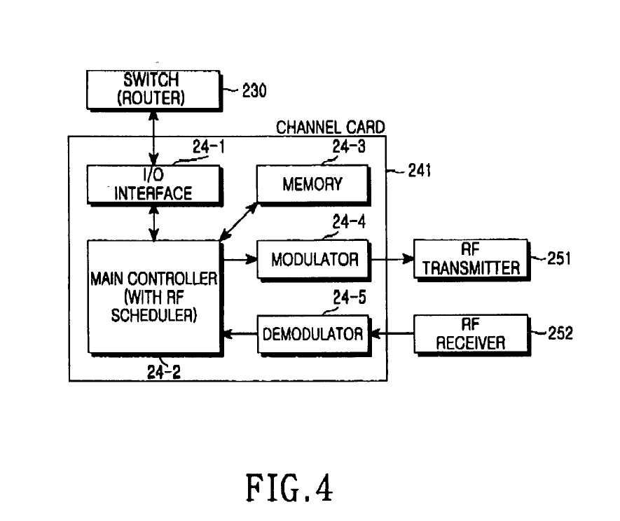

FIG. 4 is a detailed block diagram of the channel card 241. The configuration of each channel card 241 to 243 is the same. Referring to FIG. 4, the channel card 241 includes an input/output (I/O) interface 24-1, a main controller 24-2, a memory 24-3, a modulator 24-4, and a demodulator 24-5. The modulator 24-4 modulates data and control signals to be transmitted to the MS 11 via the RF transmitter 251 in the RF transmitter/receiver 250. The demodulator 24-5 demodulates data and control signals received from the MS 11 through the RF receiver 252 in the RF transmitter/receiver 250. The memory 24-3 has a buffer for receiving packet data directed to the MS 11 from the BSC 40 and temporarily storing it. The memory 24-3 stores control information.

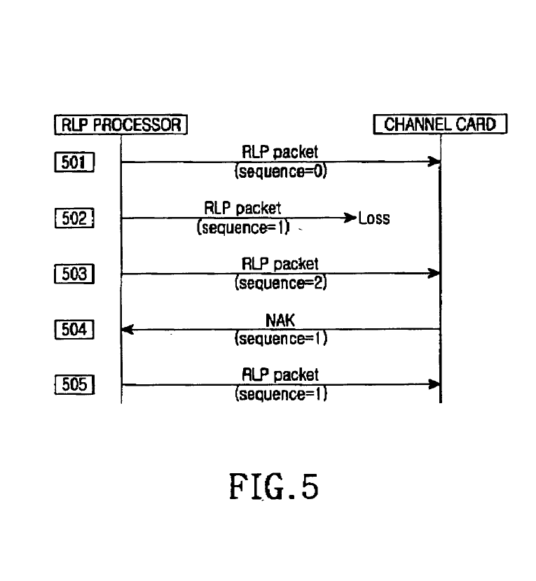

FIG. 5 is a diagram illustrating a signal flow for packet (RLP packet) retransmission according to the embodiment of the present invention. In the retransmission procedure, packet data for an MS lost during its transmission from a BSC to a BTS is retransmitted. In FIG. 5, an RLP processor is the SDU/RLP processor 41 of the BSC 40 and a channel card is, for example, the channel card 241 in the BTS to which the MS belongs.

Referring to FIG. 5, the RLP processor transmits an RLP packet having a sequence number of 0 to the channel card in step 501 and transmits an RLP packet having a sequence number of 1 but loses it in step 502. In step 503, the RLP processor transmits an RLP packet having a sequence number of 2 to the channel card and the channel card determines that the RLP packet having the sequence number 1 has been lost. The channel card requests from the RLP processor by IPC a retransmission of the RLP packet having the sequence number 1. For IPC, the channel card can use an NACK (Non-Acknowledgement) message. Upon receipt of the NACK message, the RLP processor retransmits the RLP packet having the sequence number 1 to the channel card in step 505. After the RLP packet having the sequence number 1 is recovered, the channel card rearranges the recovered packet and the initially received packets according to the sequence numbers and wirelessly transmits them according to the RLP sequence to the MS.

While packet data lost during its transmission between the BSC and the BTS is detected in the MS and then recovered in the conventional packet data retransmission, the BTS detects the packet loss and the packet is recovered correspondingly in the present invention.

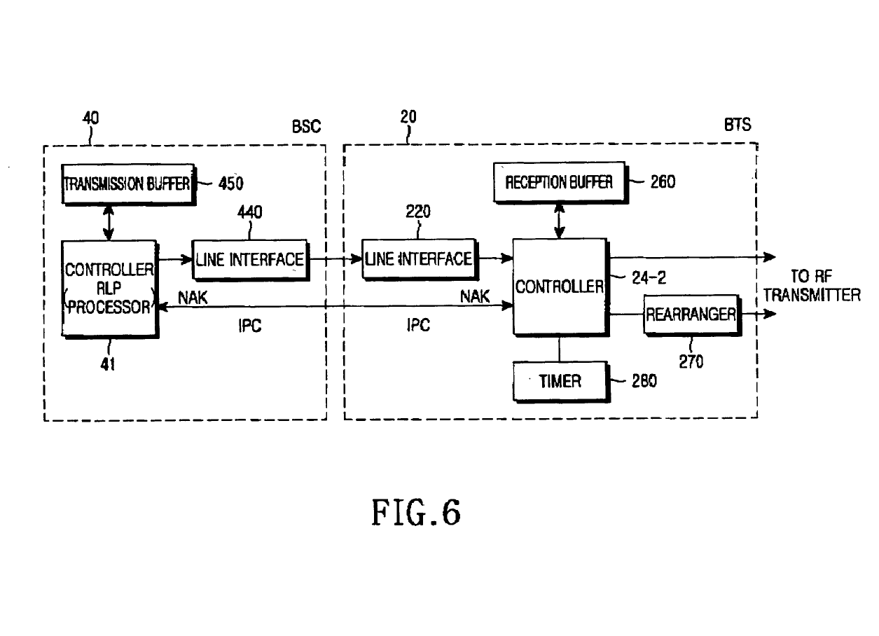

FIG. 6 is a detailed block diagram of the BSC 40 and the BTS 20 for packet data retransmission according to the embodiment of the present invention. Referring to FIG. 6, the BSC 40 includes the controller 41, a transmission buffer 450, and the line interface 440. The controller 41 controls packet data transmission to the BTS. Especially, upon receipt of an NACK message for a packet from the BTS 20, the controller 41 retransmits the packet. The controller 41 corresponds to the SDU/RLP processor 41 illustrated in FIG. 2. The transmission buffer 450 stores packet data to be transmitted. The line interface 440 interfaces between the BSC 40 and the BTS 20.

The BTS 20 includes the controller. 24-2, the line interface 220, a reception buffer 260, a rearranger 270, and a timer 280. The controller 24-2 receives packet data directed to the MS from the MSC and transmits it to the MS on a radio link when reverse transmission is available. Especially, the controller 24-2 detects a lost packet by checking the sequence numbers of packets stored in the reception buffer 260. When a packet loss is detected, the controller 24-2 transmits an NACK message requesting a retransmission of the lost packet to the controller 41 of the BSC 40 by IPC. The controller 24-2 corresponds to the main processor 24-2 illustrated in FIG. 4. The line interface 220 interfaces the BSC 40 with the BTS 20. The reception buffer sequentially stores packet data received from the BSC 40. The rearranger 270 rearranges packets stored in the reception buffer 260 after a packet is lost and the packet retransmitted from the BSC 40 under the control of the controller 24-2. The rearranged packet data is transmitted to the MS through the RF transmitter 251 illustrated in FIG. 4. The timer 280 is activated for a predetermined time period when the controller 24-2 requests a packet retransmission. While the timer 280 is separated from the controller 24-2 for illustrative purposes, it may be built in the controller 24-2. If packet data of which the retransmission has been requested is not received within the predetermined time, the controller 24-2 transmits packet data excluding the lost packet to the MS. The reception buffer 260, the controller 24-2, the rearranger 270, and the timer 280 are located in each channel card.

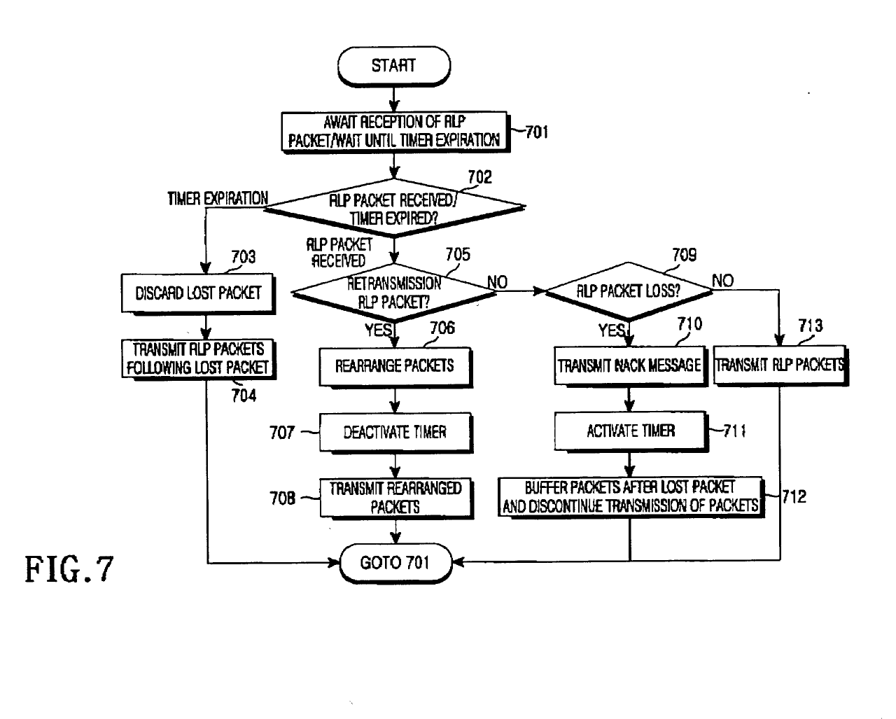

FIG. 7 is a flowchart illustrating the operation of the controller 24-2 illustrated in FIG. 6 in the BTS 20 for packet data retransmission according to the embodiment of the present invention.

Referring to FIG. 7, the controller 24-2 awaits receipt of an RLP packet or waits until a timer for receiving a retransmission request is expired in step 701. Upon receipt of an RLP packet in step 702, the controller 24-2 determines whether the RLP packet has been received in response for a retransmission request in step 705. The determination can be made by many ways. For example, the controller 41 in the BSC 40 retransmits the RLP packet, notifying that it is a retransmission packet using a specific field in an IPC message. If the RLP packet is a retransmission packet, the controller 24-2 rearranges previously buffered RLP packets and the retransmitted RLP packet according to their sequence numbers in step 706. The buffered RLP packets may have the sequence numbers following that of the retransmitted RLP packet. In step 707, the controller 24-2 deactivates the timer 280 that was activated for requesting the retransmission. The controller 24-2 outputs the rearranged packets for radio transmission in step 708.

On the other hand, if the received RLP packet is not a retransmission packet in step 705, the controller 24-2 determines whether there is a lost packet among received RLP packets by checking their sequence numbers. If packet loss is detected in step 709, the controller 24-2 transmits an NACK message for requesting a retransmission of the lost packet to the BSC 40 controller 41 by IPC in step 710. The NACK message can be constructed in the same frame structure as that of an RLC (Radio Link Control) retransmission request message in WCDMA. In step 711, the controller 24-2 activates the timer 280. The controller 24-2 buffers RLP packets received after the retransmission request is transmitted in the reception buffer 260 and discontinues transmission of the RLP packets in step 712.

If the received RLP packet is not a retransmission packet in step 705 and if no packet loss has occurred in step 709, this implies that the received RLP packet is normal. Then the controller 24-2 buffers the RLP packet in the reception buffer 260 and outputs it for radio transmission in step 713.

When the BSC 40 fails to retransmit a packet before the timer 280 expires, the controller 24-2 determines to discard the lost RLP packet in step 703 and outputs the RLP packets received after the lost packet buffered in the reception buffer 260, for radio transmission in step 704.

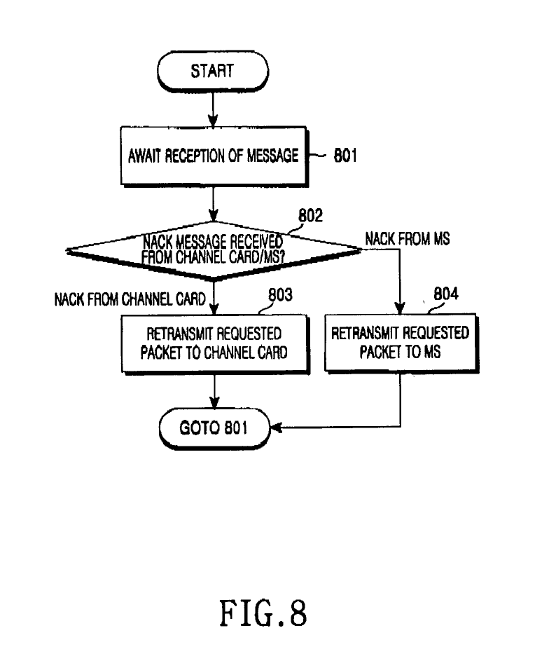

FIG. 8 is a flowchart illustrating the operation of the controller 41 illustrated in FIG. 7 in the BSC 40, for packet data retransmission upon receipt of a retransmission request according to the embodiment of the present invention. The retransmission request may be received from the MS for packet data lost during its transmission on the radio link between the BTS 20 and the MS, or from the BTS 20 for packet data lost during its transmission on the wired link between the BSC 40 and the BTS 20.

Referring to FIG. 8, the controller 41 awaits reception of a message in step 801. Upon receipt of an NACK message, the controller 41 determines whether the NACK message is from a channel card in the BTS 20 or from the MS in step 802. In the former case, the NACK message is received by IPC, and in the latter case, it is received at the line interface 440 from the MS through the BTS 20. Thus the BSC 40 can determine the transmission source of the NACK message. If the NACK message is from the channel card in the BTS 20, the controller 41 retransmits a requested RLP packet to the channel card in the BTS 20 in step 803. On the other hand, if the NACK message is from the MS, the controller 41 retransmits the requested packet to the MS through the BTS 20 in step 804. The requested packet is transmitted to the BTS 20 through the line interface 440 in both cases. Here, a frame containing the retransmission RLP packet has a retransmission bit. If the retransmission bit is set, this implies that the RLP packet is retransmitted due to an error on the radio link, and if the retransmission bit is not set, this implies that the RLP packet is retransmitted due to an error on the wired link. Therefore, the BTS 20 processes the RLP packet correspondingly according to the retransmission bit. Besides the retransmission bit, the controller 41 can define a field indicating IPC-based retransmission or normal transmission.

In accordance with the present invention, when an error is generated in packet date during its transmission on a wired link between a BSC and a BTS, the BTS requests a retransmission of the packet data to the BSC. Therefore, unnecessary consumption of radio resources and transmission delay are prevented, which are encountered in the conventional retransmission method where an MS detects an error in packet data on a wired link and requests a retransmission of the packet data.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of retransmitting packet data lost during transmission between a BSC (Base Station Controller) and an MS (Mobile Station) through a BTS (Base Transceiver System) in the BTS of a mobile communication system where the BTS communicates with the MS, and the BSC is connected to the BTS, comprising the steps of:
sequentially receiving packets from the BSC and determining whether there is a lost packet; and
buffering packets received after the lost packet when packet loss occurs and requesting to the BSC a retransmission of the lost packet.

2. The method of claim 1, further comprising the steps of:
retransmitting to the BTS by the BSC the lost packet in response to the retransmission request; and
rearranging sequentially the retransmitted packet and the buffered packets and transmitting by the BTS the rearranged packets to the MS.

3. The method of claim 1, further comprising the step of determining by the BTS whether the requested packet has been received within a predetermined time period after the retransmission request is transmitted.

4. The method of claim 3, further comprising the step of transmitting by the BTS the buffered packets to the MS if the requested packet is not received from the BSC within the predetermined time period.

5. The method of claim 1, wherein the BTS determines whether packet loss has occurred by checking the sequence numbers of the packets received from the BSC.

6. The method of claim 1, wherein the BTS requests the retransmission to the BSC by inter-processor communication (IPC).

7. An apparatus for requesting retransmission of lost packet data between a BSC (Base Station Controller) and an MS (Mobile Station) through a BTS (Base Transceiver System) in the BTS of a mobile communication system where the BTS communicates with the MS and the BSC is connected to the BTS, comprising:
a reception buffer for sequentially receiving packets from the BSC and buffering the packets; and
a controller for determining whether there is a lost packet; and requesting a retransmission of the lost packet to the BSC when packet loss occurs.

8. The apparatus of claim 7, further comprising a rearranger for rearranging packets retransmitted in response to the retransmission request and packets buffered after the lost packet.

9. The apparatus of claim 7, further comprising a timer for counting a predetermined time period when the retransmission of the lost packet is requested.

10. The apparatus of claim 9, wherein the controller outputs the packets buffered after the lost packet, for transmission, if the requested packet is not received within the predetermined time period.

11. The apparatus of claim 7, wherein the retransmission of the lost packet is requested to the BSC by inter-processor communication (IPC).
